(19) United States
(12) Patent Application Publication
(10) Pub. No.: US 2005/0254608 A1
(43) Pub. Date: Nov. 17, 2005

(54) METHOD AND APPARATUS FOR ANTENNA DIVERSITY

(76) Inventors: Liang-Hui Lee, Tai-Nan City (TW); Chun-Ming Cho, Chi-Lung City (TW); Kuang-Yu Yen, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 10/908,238

(22) Filed: May 4, 2005

(30) Foreign Application Priority Data
May 11, 2004 (TW) 093113197

(51) Int. Cl. H04B 7/10; H04L 1/02

(52) U.S. Cl. 375/347

(57) ABSTRACT

A method for antenna diversity includes: determining a first strength of the first antenna according to a received signal received by the first antenna; receiving the guard interval of a first symbol or a second symbol or both using the second antenna and determining a second strength of the second antenna; and determining which one of the first and the second antennas to receive the useful duration of the second symbol according to the first and the second strengths.

### BACKGROUND OF INVENTION

1. Field of the Invention

The present invention relates to a communication system, and more particularly, to method and apparatus for antenna diversity in a communication system.

2. Description of the Prior Art

Currently, conventional analog TV signal broadcasting is gradually transforming into digital video broadcasting (DVB). In the DVB-T standard, signals are processed using a COFDM (Coded Orthogonal Frequency Division Multiplexing) technique. The DVB-T standard is a continuous OFDM system.

The DVB-T system is able to support mobile receipt, and typically uses twin antennas to receive signal.

According to the IEEE 802.11a or 11g standard, a symbol is composed of three parts: a preamble, a guard interval (GI) and data. A conventional antenna diversity method applied in the IEEE 802.11a or 11g standard measures strength of the antennas during the receipt of the preamble. However, in the DVB-T standard, a symbol is composed of a guard interval and a useful duration but no preamble. Additionally, in TV broadcasting systems, the facts that video transmission cannot be interrupted and signals cannot be re-transmitted should also be considered.

FIG. 1 depicts a schematic diagram of a conventional DVB receiver 100. The conventional DVB receiver 100 has two antennas 110 and 140, two tuners 120 and 150, and two demodulators 130 and 160. The receiver 100 employs a comparing circuit 170 to compare the strength of the output signal of the first demodulator 130 and the second demodulator 160 so as to select either the antenna 110 or the antenna 140 to receive signals.

In other words, the conventional receiver 100 uses two receiving modules that have the same properties to process the signals received by the first antenna 110 and the second antenna 140, respectively. As a result, the cost and circuitry size of the conventional receiver 100 are accordingly increased.

### SUMMARY OF INVENTION

It is therefore an objective of the claimed invention to provide a method and apparatus of antenna diversity capable of reducing circuitry complexity and cost.

According to a preferred embodiment of the present invention, a receiver comprises: a first antenna and a second antenna; a switch for selecting one of the first and second antennas to receive an incoming signal according to a control signal; a tuner for converting the incoming signal; a demodulator for demodulating the signal output from the tuner; and a detecting unit for respectively measuring strengths of the incoming signal received by the first and second antennas, and generating the control signal according to the strengths of the incoming signal received by the first and the second antennas; wherein the switch switches the antennas during a guard interval of the incoming signal.

According to the embodiment of the present invention, a method of antenna diversity in a receiver is disclosed. The method comprises: receiving a useful duration of a first symbol of an incoming signal using a first antenna; detecting a signal strength of the first symbol before a useful duration of a second symbol to produce a first strength; detecting a signal strength for a second antenna before the useful duration of the second symbol to produce a second strength; and comparing the first and the second strengths to determine which one of the first and second antennas receives the useful duration of the second symbol.

According to the embodiment of the present invention, another method of antenna diversity in a receiver is disclosed. The method comprises: determining a first strength of the first antenna according to a received signal received by the first antenna; determining a second strength of the second antenna when at least one of the guard interval of the first symbol and the second symbol is received by the second antenna; and determining which one of the first and the second antenna to receive the useful duration of the second symbol according to the first and the second strengths.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a conventional DVB receiver.

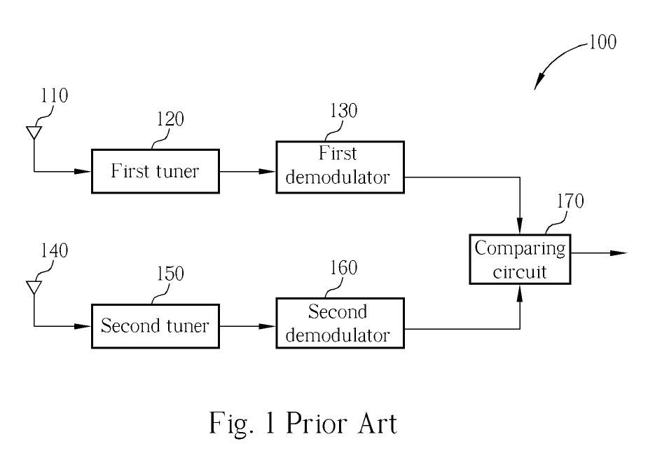

FIG. 2 shows a schematic diagram of an incoming signal of the DVB-T standard.

FIG. 3 is a block diagram of a DVB receiver according to a preferred embodiment of the present invention.

FIG. 4 is a flowchart of antenna diversity according to the present invention.

### DETAILED DESCRIPTION

In the DVB-T standard, the transmitted signal is organized in frames. Each frame consists of 68 OFDM symbols. Each symbol is composed of two parts: a guard interval used for preventing an ISI (Inter-Symbol Interference) problem, and a useful duration used for transmitting data.

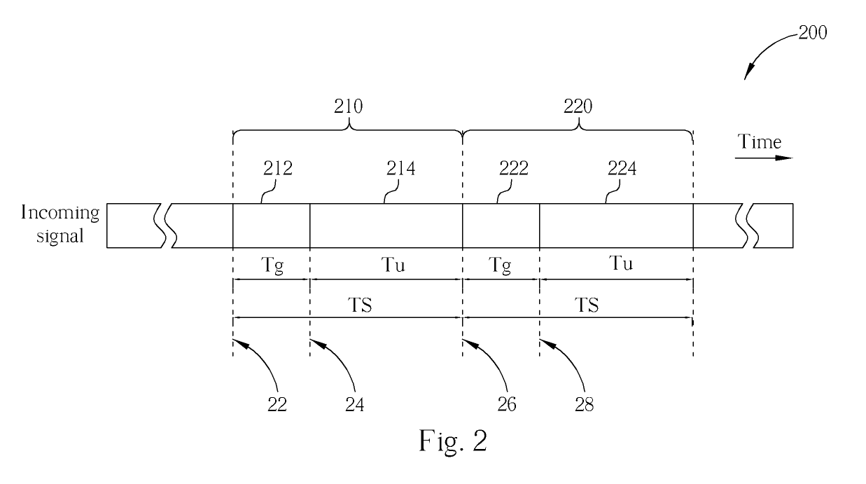

Please refer to FIG. 2, which shows a schematic diagram of an incoming signal 200 defined in the DVB-T standard. As shown, a first symbol 210 comprises a guard interval 212 and a useful duration 214, and a second symbol 220 comprises a guard interval 222 and a useful duration 224. Each of the guard intervals 212 and 222 has duration of Tg, and each of the useful durations 214 and 224 has duration of Tu. In other words, each of the first symbol 210 and the second symbol 220 has duration of TS (TS=Tg+Tu).

In the DVB-T standard, the guard interval of each symbol is the cyclic prefix of the useful duration of the symbol. Depending on the transmission mode, the duration Tg of the guard interval can vary, and may have values such as ¼Tu, ⅛Tu, 1/16Tu, 1/32Tu and so on.

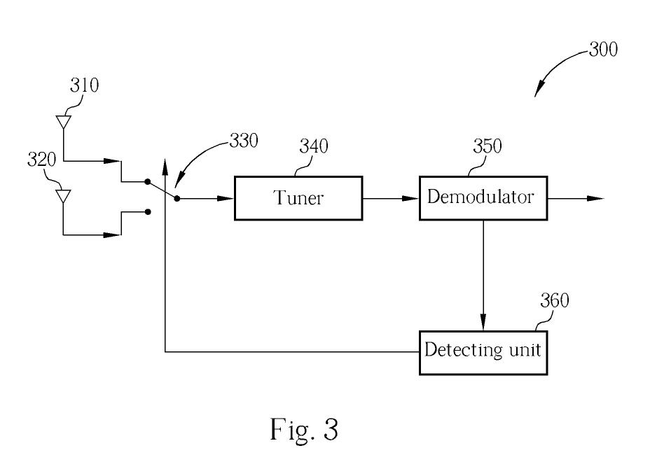

Please refer to FIG. 3, which depicts a block diagram of a DVB receiver 300 according to a preferred embodiment of the present invention. The receiver 300 comprises a first antenna 310, a second antenna 320, a switch 330 used for switching between the first and second antennas 310 and 320, a tuner 340 used for down-converting a received incoming signal, a demodulator 350 for decoding and demodulating the signal output from the tuner 340, and a detecting unit 360 used for detecting and comparing the signal strength of the first antenna 310 and the second antenna 320 to control the switch 330. In practical implementations, the tuner 340 typically uses an AGC (Automatic Gain Control—not shown) circuit to adjust the gain of the received incoming signal.

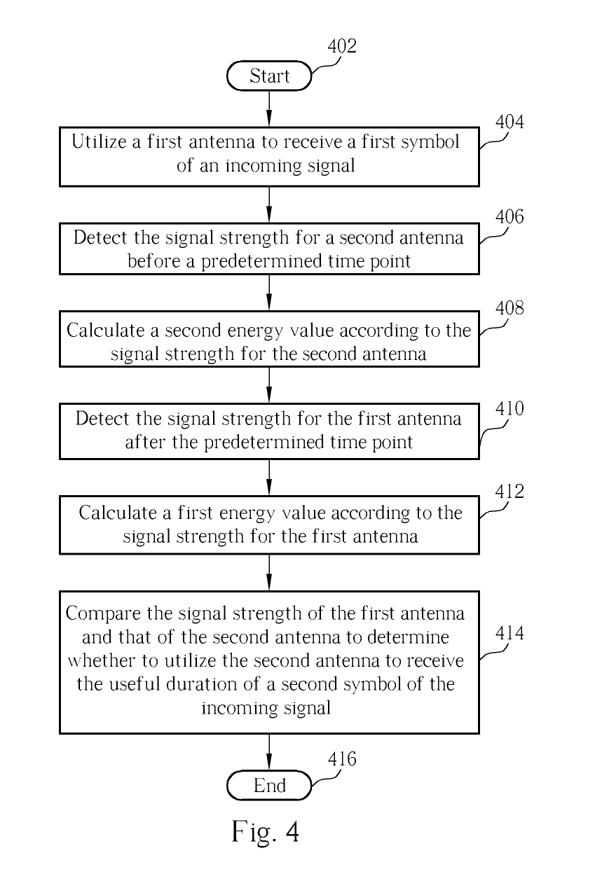

Please refer to FIG. 4, as well as FIG. 2. FIG. 4 is a flowchart describing the antenna selection made by the receiver 300 according to one embodiment of the present invention. The steps of the flowchart are described as follows:

First, the receiver 300 of the present invention selects one antenna (such as the first antenna 310) to perform signal synchronization and boundary acquisition.

After the boundary acquisition is finished, the receiver 300 performs step 404 to use the first antenna 310 to receive the guard interval 212 of the first symbol 210 of the incoming signal 200.

Next, in step 406, the detecting unit 360 controls the switch 330 to switch to the second antenna 320 before a predetermined time point 24 so as to detect the signal strength of the second antenna 320. In a preferred embodiment, the detecting unit 360 controls the switch 330 to switch to the second antenna 320 when the first antenna 310 receives the front boundary of the guard interval 212 of the first symbol 210, i.e., at the time point 22.

In step 408, the detecting unit 360 calculates a second energy value energy_{—}2 according to the signal strength of the second antenna 320.

In step 410, the detecting unit 360 then detects the signal strength of the first antenna 310 after the predetermined time point 24. In practical implementations, switching between circuits or signal transitions may cause delays, so the detecting unit 360 can control the switch 330 to switch back to the first antenna 310 at a short period before the predetermined time point 24 so as to detect the signal strength of the first antenna 310. Similarly, the detecting unit 360 calculates a first energy value energy_{—}1 according to the signal strength of the first antenna 310 in step 412.

In an embodiment, the AGC of the tuner 340 maintains the same gain property in step 406 and step 410 in order to improve the accuracy of signal strength measured by the detecting unit 360.

In an embodiment, the first and the second energy values (energy_{—}1, energy_{—}2) correspond to the cyclic prefix and the guard interval of the symbol, respectively. The guard interval of each symbol is the cyclic prefix of the useful duration.

In step 414, the detecting unit 360 compares the first energy value energy_{—}1 and the second energy value energy_{—}2 to determine whether to change to the second antenna 320 to receive the useful duration 224 of the following second symbol 220. In an embodiment, the switch 330 switches the antennas during the guard interval of the symbol so as to ensure the receipt of the useful durations of the symbols. In other words, the receipt of the useful durations of the symbols is guaranteed by inhibiting switching antennas during the useful duration of the symbols. In practice, the detecting unit 360 can employ various criteria to determine whether to change to the second antenna 320 in step 414. For example, in a first embodiment of the present invention, if the second energy value energy_{—}2 is greater than the first energy value energy_{—}1, the detecting unit 360 controls the switch 330 to switch to the second antenna 320 before a time point 28. In a second embodiment of the present invention, the detecting unit 360 controls the switch 330 to switch to the second antenna 320 only if the second energy value energy_{—}2 exceeds the first energy value energy_{—}1 by a specific amount, such as 3 dB. In a third embodiment of the present invention, the detecting unit 360 does not only compare the second energy value energy_{—}2 and the first energy value energy_{—}1, but also determines if the bit error rate (BER) of the processing/processed signal of the demodulator 350 reaches a predetermined threshold value. If the second energy value energy_{—}2 is greater than the first energy value energy_{—}1 or exceeds the first energy value energy_{—}1 by a specific amount, and the BER of the processing/processed signal of the demodulator 350 reaches the threshold value, then the signal strength of the second antenna 320 is stronger than that of the first antenna 310 and the signal quality of the first antenna 310 is poor. In this situation, the detecting unit 360 controls the switch 330 to switch to the second antenna 320 before the time point 28.

Please note that in the above steps 406 and 410, the detecting unit 360 of the present invention can respectively detect the overall signal strength of the two antennas in the same time period, or detect the average signal strength of the two antennas in different time periods.

Additionally, in the foregoing step 410, the detecting unit 360 measures the signal strength of the first antenna 310 after the predetermined time point 24. This is only an embodiment of the resent invention and does not limit other implementations of the present invention. For example, if the length of the guard interval of the symbol of the incoming signal is enough, the detecting unit 360, in step 410, can successively detect the signal strength of the second antenna 320 and the first antenna 310 during the guard interval 212 of the first symbol 210. In fact, the detection period of the signal strength of the first antenna 310 can cross the boundary between the guard interval 212 and the useful duration 214 of the first symbol 210, i.e., the time point 24. In other words, the present invention allows other embodiments having the feature that the signal strength of the second antenna 320 is detected during the guard interval of a symbol.

In practical implementations, the detecting unit 360 can perform a plurality of detections of signal strength to the first antenna 310 and the second antenna 320, respectively, in several symbol periods, and then employ the overall or average signal strength of each antenna as the first energy value energy_{—}1 and the second energy value energy_{—}2 to perform the comparison in step 414.

As is well known in the art, the DVB-T standard defines three transmission channels: 8 MHz, 7 MHz and 6 MHz. The frame structure, sub-carrier numbers and channel coding are substantially the same between DVB-T systems with different channels. The difference between channels of different bandwidths is the duration Tu of the useful duration of the symbol. Therefore, the foregoing receiver and antenna diversity method of the present invention can be applied in different DVB systems or different OFDM systems.

Those skilled in the art will readily observe that numerous modifications and alterations of the device and method may be made while retaining the teachings of the invention. Accordingly, the above disclosure should be construed as limited only by the metes and bounds of the appended claims.

1. A receiver comprising:
a first antenna and a second antenna;
a switch coupled to the first and second antennas, for selecting one of the first and second antennas to receive an incoming signal according to a control signal;
a tuner coupled to the switch for converting the incoming signal;
a demodulator coupled to the tuner for demodulating the signal output from the tuner; and
a detecting unit for respectively measuring strengths of the incoming signal received by the first and second antennas, and generating the control signal according to the strengths of the incoming signal received by the first and the second antennas;
wherein the switch switches the antennas during a guard interval of a symbol of the incoming signal.

2. The receiver of claim 1, wherein the detecting unit respectively calculates a first energy value and a second energy value according to the strengths of the signals received by the first and the second antennas, and generates the control signal based on the first and second energy values.

3. The receiver of claim 2, wherein if the second energy value is greater than the first energy value, the receiver utilizes the second antenna to receive the useful duration of the incoming signal.

4. The receiver of claim 3, wherein the receiver utilizes the second antenna to receive the incoming signal when a number of error bits of the incoming signal received by the first antenna reaches a predetermined threshold.

5. The receiver of claim 1, wherein the detecting unit controls the switch to switch to the second antenna when a number of error bits of the incoming signal received by the first antenna reaches a predetermined threshold.

6. The receiver of claim 1, wherein the tuner comprises a gain control circuit, a gain of the gain control circuit is substantially constant during the detection of the strengths of the first and second antennas.

7. The receiver of claim 1, wherein the incoming signal is an OFDM (Orthogonal Frequency Division Multiplexing) modulated signal.

8. The receiver of claim 1, wherein the incoming signal is compliant with a DVB (digital video broadcasting) standard.

9. A method for antenna diversity comprising:
receiving a useful duration of a first symbol of an incoming signal using a first antenna;
detecting a signal strength of the first symbol before a useful duration of a second symbol to produce a first strength;
detecting a signal strength for a second antenna before the useful duration of the second symbol to produce a second strength; and
comparing the first and the second strengths to determine which one of the first and second antennas receives the useful duration of the second symbol.

10. The method of claim 9, further comprising:
inhibiting switching antennas during the useful duration of the symbols.

11. The method of claim 9, wherein the comparing step further comprises:
if the second strength is greater than the first strength, utilizing the second antenna to receive the useful duration of the second symbol.

12. The method of claim 11, wherein the comparing step further comprises:
if a number of error bits corrected based on an Reed-Solomon code reaches a predetermined value, utilizing the second antenna to receive the useful duration of the second symbol.

13. The method of claim 9, wherein the incoming signal is an OFDM modulated signal.

14. The method of claim 9, wherein the incoming signal is compliant with a DVB (digital video broadcasting) standard.

15. A method of antenna diversity in a receiver having a first antenna and a second antenna, the receiver for receiving a first symbol and a second symbol, wherein each symbol includes a guard interval and a useful duration, the method comprising: determining a first strength of the first antenna according to a received signal received by the first antenna;
determining a second strength of the second antenna according to the guard interval of the first symbol or the second symbol or both received by the second antenna; and
determining which one of the first and the second antenna to receive the useful duration of the second symbol according to the first and the second strengths.

16. The method of claim 15, further comprising:
inhibiting switching antennas during the useful duration of the symbols.

17. The method of claim 15, wherein the first and the second strengths correspond to the guard intervals of the first and the second symbols, respectively.

18. The method of claim 15, wherein the first strength corresponds to a portion of the useful duration of the first symbol.

19. The method of claim 15, wherein the first strength corresponds to a cyclic prefix of the useful duration of the first symbol.

20. The method of claim 19, wherein the second strength corresponds to the guard interval of the first symbol.
